(19) United States
(12) Patent Application Publication
(10) Pub. No.: US 2003/0062663 A1
(43) Pub. Date: Apr. 3, 2003

(54) Convertible engine stand

(75) Inventor: Robert Fox, Wilmington, CA (US)

Correspondence Address: HAHN LOESER & PARKS, LLP, TWIN OAKS ESTATE, 1225 W. MARKET STREET, AKRON, OH, 44313, US

(73) Assignee: Norco Industries, Inc.

(21) Appl. No.: 10/241,668

(22) Filed: Sep. 11, 2002

Related U.S. Application Data
(60) Provisional application No. 60/326,539, filed on Oct. 1, 2001.

(51) Int. Cl. B23Q 3/00

(52) U.S. Cl. 269/17

(57) ABSTRACT

A convertible engine stand including a base engine stand having a single vertical support and a telescopic base is used to supports engines up to one-thousand two-hundred fifty (1250) pounds. A conversion kit, including a second vertical support converts the base engine stand into one having supports for both ends of an engine and supports engines up to two-thousand (2000) pounds.

### BACKGROUND OF THE INVENTION

This invention relates generally to engine stands and more particularly to convertible engine stands. This application claims the benefit of U.S. provisional application serial No. 60/326,539, filed Oct. 1, 2001. Application serial No. 60/326,539 is hereby incorporated by reference.

There are basically three categories of engine stands based on the sizes and weights of the engines. Automotive engines fit into a category (automotive category) that includes the smallest passenger vehicle engine all the way up to large V-8 engines that are used in one (1) ton pickup trucks and vans. Engine stands that support the automotive category engines will range up to one-thousand two-hundred fifty (1250) pound capacity. The second category of engines include the large highway diesel rigs. The engine stand capacity for large diesel engines is up to six-thousand (6000) pounds. The third category of engines that are larger than the automotive V-8 engines and smaller than the large diesel engines. These engines are sometimes gas and sometimes diesel. Engines in this third category are larger optional engines used in trucks in the automotive category and also engines used in bobtail type trucks. The engine stands that support these middle weight engines are usually rated at two-thousand (2000) pound capacity.

Because of the growing popularity of Sport Utility Vehicles (SUVs) with larger engines and the continuing popularity of large pick-up trucks, also with larger engines, repair shops, and engine re-builders, are working with both the automotive engine category of engines and the third or middle weight category of engines. This requires a repair shop to have both one-thousand two-hundred fifty (1250) pound capacity engine stands and two-thousand (2000) pound capacity engine stands.

The foregoing illustrates limitations known to exist in present engine stands. Thus, it is apparent that it would be advantageous to provide an alternative directed to overcoming one or more of the limitations set forth above. Accordingly, a suitable alternative is provided including features more fully disclosed hereinafter.

### SUMMARY OF THE INVENTION

In one aspect of the present invention, this is accomplished by providing a conversion kit for use with an engine stand including a second vertical support member adapted to be removably attached to the engine stand horizontal base; a shaft rotatably attached to the vertical support member; and an adapter plate for attachment to the shaft and adapted to be attached to an engine.

In a second aspect of the present invention, this is accomplished by providing a base engine stand comprising: a telescopically adjustable horizontal base member; a vertical support member attached to the horizontal base member; a shaft rotatably attached to the vertical support member; an adapter plate for attachment to the shaft and adapted to be attached to an engine; and a means for rotating the shaft.

In a third aspect of the present invention, this is accomplished by providing a convertible engine stand comprising: a telescopically adjustable horizontal base member; a first vertical support member attached to the horizontal base member; a first shaft rotatably attached to the first vertical support member; an adapter plate for attachment to the first shaft and adapted to be attached to an engine; a means for rotating the first shaft; a second vertical support member removably attached to the horizontal base member; a second shaft rotatably attached to the first vertical support member; and an adapter plate for attachment to the second shaft and adapted to be attached to an engine.

The foregoing and other aspects will become apparent from the following detailed description of the invention when considered in conjunction with the accompanying drawing figures.

### BRIEF DESCRIPTION OF THE DRAWING FIGURES

FIG. 1 is an exploded perspective view of an engine stand in accordance with the present invention.

FIG. 2 is a front elevational view of the horizontal base member in accordance with the present invention.

### DETAILED DESCRIPTION

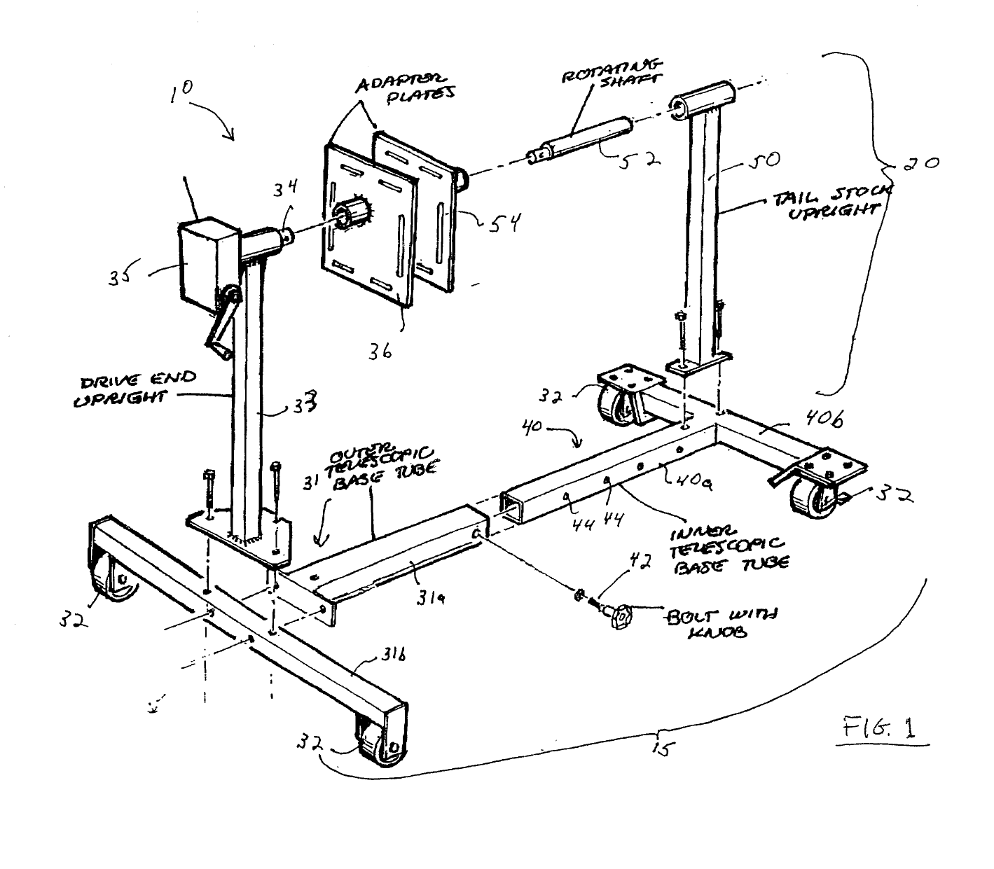

Shown in FIG. 1 is a convertible engine stand 10 according to one embodiment of the present invention. Engine stand 10 consists of a base engine stand 15, which can function as a one-thousand two-hundred fifty (1250) pound engine stand and a conversion kit 20, which converts the one-thousand two-hundred fifty (1250) pound base engine stand 15 into a two-thousand (2000) pound engine stand.

In a preferred embodiment, the base engine stand 15 includes a first T-shaped horizontal base member or outer telescopic base tube 31, which is preferably formed of a cross-support 31b connected to a center support 31a. Although shown as being removably attached to the center support 31a, cross-support 31b can be welded, otherwise permanently attached or formed with center support 31a. It is also contemplated that the base engine stand may be formed using other configurations such as an I-shaped and a T-shaped member. Wheels or casters 32 are attached to the outboard ends of cross-support 31b.

Although shown as fixed wheels, caster wheels or other types of pivotable wheels can be used. A vertical support or drive end upright 33 is attached to the center of cross-support 31b and center support 31a. Although shown as being removably attached to the supports 31a, 31b, vertical support 33 could be permanently attached to the supports 31a, 31b.

A shaft 34 is rotatably attached to the top of vertical support 33. A drive mechanism (gear box) 35 connects to shaft 34 to rotate an attached engine (not shown). In addition to the gear box 35 shown, other drive mechanisms, such as a long bar, could be used to rotate the engine. An adapter plate 36, connected to the drive shaft, is used to attach an engine to the engine stand 10. Different adapter plate configurations are used for different engines. Adapter arms (not shown) are frequently used with the adapter plates 36, 54 to attach an engine to the engine stand 10. Usually, adapter plates 36, 54 are identical to one another.

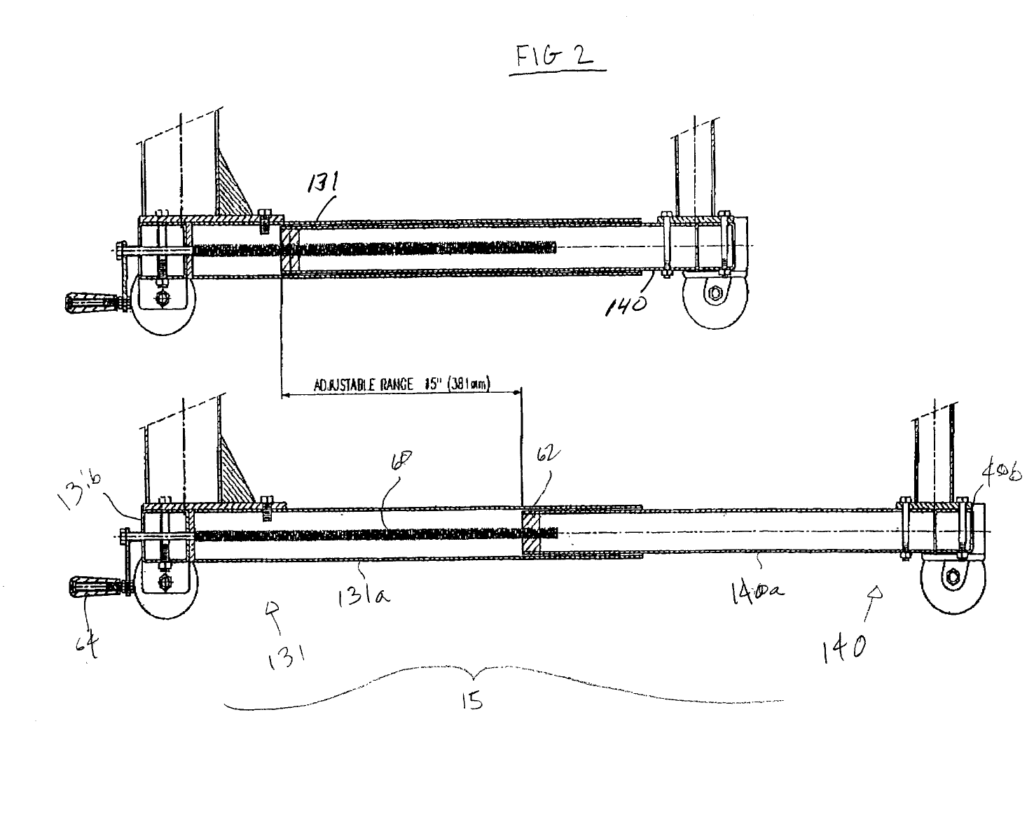

To complete the base engine stand 15, a second T-shaped horizontal base member or inner telescopic base tube 40 is telescopically attached to the outer telescopic base tube 31. While it is a preferred embodiment to utilize a screw driven mechanism (FIG. 2) to telescopically attach the first T-shaped horizontal base member 31 to the second T-shaped horizontal base member 40, other means have been contemplated, one such design utilizing threaded bolts to lock the respective members in an integrally mated position (which engage a selectively positioned threaded hole located in each T-shaped horizontal base member) as shown in FIG. 1. The inner telescopic base tube has a plurality of spaced apart threaded holes 44. A threaded bolt and knob 42 is provided to secure the inner telescopic base tube 40 to the outer telescopic base tube 31 by engaging the appropriate threaded hole 44. The inner telescopic base tube 40 consists of a cross-support 40b connected to a center support 40a. Wheels or casters 32 are attached to the outboard ends of cross-support 40b.

To convert the base engine support 15, a conversion kit 20 including a vertical support or tail stock upright 50 removably attached to the center of cross-support 40b and center support 40a; a shaft 52 rotatably attached to the top of vertical support 50; and additional adapter plates 36, 54, connected to shaft 52 and used to attach an engine to engine stand 10, is provided. Since adapter plates for a two-thousand (2000) pound engine stand are different than the adapter plates for a one-thousand two-hundred fifty (1250) pound engine stand, conversion kit 20 usually includes two additional adapter plates 36, 54. The telescopic connection of inner telescopic base tube 40 to outer telescopic base tube 31 permits the distance between vertical supports 33, 50 to be adjusted to accommodate different size engines.

In use, the basic engine stand 15, with a single vertical support 33, is used to support engines up to one-thousand two-hundred fifty (1250) pounds. By adding the optional conversion kit 20, a second vertical support 50, rotating shaft 52 and additional adapter plates 36, 54 are added to the base engine stand 15, providing support for an engine at both ends and supporting engines up to two-thousand (2000) pounds. When vertical support 50 is removed, the inner and outer telescopic tubes 40, 31 can be collapsed together to form the average engine stand length of a one-thousand two-hundred fifty (1250) pound capacity automotive engine stand.

FIG. 2 describes a preferred method of telescopically attaching the first T-shaped horizontal base member 131 to the second T-shaped horizontal base member 140. In this embodiment, a threaded end cap 62 is selectively secured to the open end of center support 140a. It is contemplated that the end cap 62 may be attached by welding, adhesives, or other mechanical means. A screw drive rod 60 is placed inside center support 131a and though cross-support 131b, there being rotatably secured thereto. The end of rod 60 being exposed from cross-support 131b is attached to a handle 64, while the other end rotatably mates with threaded hole of end cap 62.

1. An engine stand comprising:
a telescopically adjustable horizontal base member including two horizontally extending telescopic members, one telescopic member slidingly fitted within the other telescopic member;
a first vertical support member attached to the horizontal base member;
a first shaft rotatably attached to the first vertical support member;
an adapter plate for attachment to the first shaft and adapted to be attached to an engine;
means for rotating the first shaft;
a second vertical support member removably attached to the horizontal base member;
a second shaft rotatably attached to the second vertical support member; and
an adapter plate for attachment to the second shaft and adapted to be attached to an engine.

2. The engine stand according to claim 1, wherein the horizontal base member comprises two telescopically attached T-shaped sections.

3. The engine stand according to claim 1, further comprising a plurality of wheels attached to the horizontal base member.

4. The engine stand according to claim 1, wherein the first vertical support member is removably attached to the horizontal base member.

5. An engine stand comprising:
a telescopically adjustable horizontal base member, wherein the horizontal base member comprises two telescopically attached T-shaped sections;
a vertical support member attached to the horizontal base member;
a shaft rotatably attached to the vertical support member;
an adapter plate for attachment to the shaft and adapted to be attached to an engine; and
a means for rotating the shaft.

6. The engine stand according to claim 5, further comprising a plurality of wheels attached to the horizontal base member.

7. The engine stand according to claim 5, wherein each T-shaped section includes a horizontally extending telescopic member, one telescopic member slidingly fitted within the other telescopic member.

8. A conversion kit for use with an engine stand, the engine stand including a telescopically adjustable horizontal base member comprising two horizontally extending telescopic members, one telescopic member slidingly fitted within the other telescopic member; a first vertical support member attached to the horizontal base member; a shaft rotatably attached to the vertical support member; an adapter plate for attachment to the shaft and adapted to be attached to an engine; and a means for rotating the shaft, the conversion kit comprising:
a second vertical support member adapted to be removably attached to the engine stand horizontal base member;
a shaft rotatably attached to the vertical support member; and
an adapter plate for attachment to the shaft and adapted to be attached to an engine.

9. An engine stand comprising:
a telescopically adjustable horizontal base member comprising two T-shaped base sections, each T-shaped section having a cross member attached to a telescopic member, one T-shaped base section telescopic member slidingly fitted within the other T-shaped base section telescopic member;
a first vertical support member attached to the horizontal base member;
a first shaft rotatably attached to the first vertical support member;
an adapter plate for attachment to the first shaft and adapted to be attached to an engine;
means for rotating the first shaft;
a second vertical support member removably attached to the horizontal base member;
a second shaft rotatably attached to the second vertical support member;
an adapter plate for attachment to the second shaft and adapted to be attached to an engine; and
four wheels attached to the horizontal base member, a wheel being attached at outboard ends of each T-shaped base section cross member.

10. The engine stand according to claim 9, wherein the vertical support members are attached at intersections of a T-shaped base section telescopic member and a T-shaped base section cross member.
